(19) United States
(12) Patent Application Publication
(10) Pub. No.: US 2015/0128477 A1
(43) Pub. Date: May 14, 2015

(54) SPINNER FISHING LURE

(71) Applicant: Christian M. Heesch, Spanish Fort, AL (US)

(72) Inventor: Christian M. Heesch, Spanish Fort, AL (US)

(21) Appl. No.: 13/619,018

(22) Filed: Sep. 14, 2012

Related U.S. Application Data
(60) Provisional application No. 61/690,704, filed on Jul. 2, 2012.

(51) Int. Cl. A01K 85/12; A01K 85/10; A01K 85/00

(52) U.S. Cl. CPC A01K 85/10
USPC 43/42.19; 43/42.02; 43/42.19; 43/42.39; 43/42.36

(57) ABSTRACT

A fishing lure having a long axis provided at its proximal portion, an elongated stiff wire shaft having a bent or looped portion on its proximal end for attaching fishing line or a swivel thereto, and a bent or looped portion on its distal end. The distal portion of said long axis is formed by either a flexible element, or by a second elongated stiff wire shaft, or by one or more split rings. At the distal end one or more hooks are attached, at least one carrying a weight element. The fishing lure includes at least one spinner blade assembly connected to a span of the proximally located stiff wire shaft, that it is free to rotate 360°. A rigid element is attached to the wire shaft between its proximal end and the spinner blade assembly, containing one or more openings representing attachment locations for fishing lines or swivels.

### CROSS-REFERENCE TO RELATED APPLICATIONS

This is a non provisional patent application of U.S. Provisional Patent Application Ser. No. 61/690,704, filed Jul. 2, 2012 Priority of U.S. Provisional Patent Application Ser. No. 61/690,704, filed Jul. 2, 2012, hereby incorporated herein by reference, is hereby claimed

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to artificial lures for fishing. More particularly, the present invention relates to an improved spinner or lure that utilizes a uniquely configured jointed lure central structure with weighted hook and a unique adjustable line attachment piece.

2. General Background of the Invention

Fishing with artificial lures is the most popular fishing method in the U.S. In very general terms, a lure, carrying a hook and attached to a fishing line, is cast into the water and pulled toward the angler. Visual appearance, motion pattern, and vibratory signals of the lure entice predatory fish to chase and swallow it, which, in turn, allows for the capture of the fish.

Spinner-type lures are one of the most popular artificial baits on the market. The two basic forms are spinners and spinner baits. Spinners (in Britain sometimes referred to as ‘bar-spoons’), feature a rotating blade mounted on a wire shaft which has a proximal loop for the attachment of fishing line, a distal loop for the attachment of a fishing hook, and usually a lure body, a weight element around the shaft located between the hook and the spinner blade. Spinner baits have two wire shafts, joined at one end by a looped connection, which serves as line attachment point and which positions the two wire shafts in the shape of a V relative to each other. One wire shaft carries one or more rotating elements for the attraction of fish, while the other wire element carries a weighted fishing hook.

Both spinner-type lures, spinners and spinner baits, primarily attract fish through the visual and vibratory signals emitted by the rotating blade, yet neither of them will catch unless the fish swallows the hook, located at some distance from the fish-attracting blade. In order to make the hook more appealing to fish, manufacturers often add decorative ‘dressing’ to its shank, such as buck tail hair or tinsel material.

While both spinners and spinner baits attract fish by the rotational movement of the spinning blade, this rotational movement is symmetric and even for spinners whose wire shaft is moving coaxially with the travel direction of the lure, whereby it is asymmetric and uneven for spinner baits, whose blades are rotating around a wire shaft which moves at an angle to the travel direction of the lure. Such uneven rotational movements introduce additional, fish attracting thumping vibrations, in theory an advantage for the spinner bait type lure over the even and less pulsating rotational signals emitted by the spinner. This advantage of spinner baits is a disadvantage at the same time, though, since the enhanced attractiveness of the blade-carrying arm of the spinner bait detracts the fish's attention from the object intended for its affection—the hook-carrying opposite arm of the lure. This problem could be tackled if it were possible to combine the advantage of the spinner (fish-catching hook and fish-attracting blade mounted in close spatial proximity on a single wire element) with the advantage of the spinner bait (emission of both rotational and pulsating vibrations owing to an angulated position of the rotational axis of the spinning blade in relation to the travel direction of the lure). It is an objective of this invention to present a spinner that fulfills these conditions.

In addition, before it can attract and catch fish, a good lure has to be cast into the right spot by the angler. Spinners, with a weighted lure body in the middle of the lure, and often bulky but light-weight dressing around a treble hook at the end, are notorious for the hook fowling the line during the casting process, subsequently preventing the lure from working properly when in the water. It is therefore an additional objective of this invention to present changes which greatly reduce the chance that the hooks fowls the line during the casting process.

Further, due to the rapid rotation of the blade around the axis of the lure, spinners often present another vexing problem: line twist. The rotating blade imparts a rotating movement on the spinner itself, which is transmitted onto the fishing line, causing its eventual entanglement and damage. It is an objective of this invention to present changes which will reduce this problem.

Lastly, all artificial lures, as opposed to natural baits, pose yet another problem to the fisherman: fish tend to come off after striking the lure by ‘throwing the hook’. Natural baits, usually presented to the fish in a static way, are often swallowed whole and deeply, with no chance for the fish to come off. Matters are different with artificial baits, which are often large, and which have to be chased by the fish. In most cases, the lure itself will remain outside the mouth of the fish, with only one of the hooks embedded lightly in its lip. Twisting and turning movements of the fish, and shaking of its head, will often lead to dislodgement of the hook and loss of the fish, with the lure serving as a lever. In general, the longer and the more rigid the lure, the easier for the fish to translate rotational and angular movements into effective leverage to ‘throw the hook’—crankbaits and spoons, but also larger spinners and spinner baits such as those designed for muskie fishing are infamous in that regard. It is therefore an objective of this invention to present changes which greatly reduce the ability of the fish to use the lure as a lever to dislodge the hook.

### BRIEF SUMMARY OF THE INVENTION

The apparatus of the present invention solves the problems confronted in the art in a simple and straightforward manner.

The apparatus has a single long axis, as opposed to the two long axes arranged in the ‘safety pin’ fashion that are typical for many spinner baits. The presented invention breaks down the single long axis into a plurality of elements. The proximal portion of this long axis is formed by a stiff wire shaft element, kept as short as possible with the minimum length dependent on the size and shape of the attached rotating blade, and ending in a proximal and a distal loop. The proximal loop can be used to attach the lure to fishing line, the distal loop is used to attach a subsequent element forming the distal portion of the lure's long axis, either a second stiff wire shaft element, or a piece of flexible material, preferably wire, or one or more split rings.

There is a rotating blade mounted on the proximal stiff wire shaft (either and preferably by way of a clevis, or by direct passing of the wire shaft through a portion of the blade), however, deviating from the traditional model, the stiff wire shaft ends right below the attachment site of the spinning blade. Traditional spinners have a lure body, a weighted element usually located distally to the spinning blade on the stiff wire shaft. This novel lure shortens the stiff wire shaft as much as possible, and features a second, possibly flexible, wire or split ring element, forming the lure's distal long axis portion, which may carry one or more lure body elements that are, in this point also deviating from the traditional model, not heavily weighted in the preferred embodiment of the invention.

The current invention features a rigid line attachment head, mounted on the proximally located wire shaft towards the proximal end thereof. This rigid line attachment element has one or more apertures which allow for the attachment of fishing line at increasing distances from the wire shaft. If the lure is attached to the line in the traditional way at the proximal end of the proximal stiff wire shaft, the shaft will follow the fishing line, and the direction of the pull, in a coaxial fashion, and the blade, rotating around the stiff wire shaft, will stay at the same angle in relation to the wire shaft throughout the 360° turn, thereby emitting regular and constant pressure signals. If the lure is attached to the line at one of the apertures located on the rigid line attachment head, the wire shaft will follow the fishing line at an angle in relation to the line and the direction of the pull, with the degree of deviation from a straight coaxial position increasing commensurate with the distance of the chosen aperture from the wire shaft. Owing to the now tilted position of the wire shaft in relation to the direction of the pull, the rotating blade will find uneven water resistance during its turn around the shaft, with maximum resistance encountered at its closest position towards the point of line attachment, and minimum resistance at its maximal distance from said point of line attachment. This varying resistance, in turn, will lead to an inverse change in the angle of rotation of the blade, with a maximum angle of rotation in relation to the shaft at the time point of minimal water resistance, and a minimum angle of rotation in relation to the shaft at the point of maximal water resistance. Now, in addition to emitting an even and constant rotational pressure signal, the lure also emits a superimposed thumping signal with each rotation, most appealing to a predatory fish's appetite and aggressive instincts. Unlike a spinner bait type lure, however, this spinner lure features the thumping signal emitting blade and the hook in close spatial proximity, on the same wire element, eliminating for the fish any and all feelings of uncertainty as to what lure part to swallow—the rotating blade or the hook—since both can be devoured with ease at the same time.

Next, this invention features at least one weight element mounted either around the shank of a hook or adjacent to its distal bends (in the case of the hook type most commonly used, the treble hook, this area is hereafter referred to as the ‘trifurcation’), and further, also departing from the design of traditional spinner lures, the current invention minimizes the weight of the lure body elements. In doing so, the current invention shifts the center of mass of the lure from its mid-portion toward its distal-most portion, the hook. Casting the lure will now inevitably put the heaviest element, the hook, ahead of all lighter elements, most notably the fishing line located on the opposing end of the wire shaft, thereby all but eliminating any possibility of the hook fowling the line.

Next, and again unlike traditional spinner lures, the long axis of the lure is formed of a plurality of segments, either two rigid but short wire elements, or a rigid wire element and a flexible wire element, mounted one after the other, or a single wire element and one or more split rings attached thereto, thereby significantly shortening the portions of the lure's total long axis which are rigid. This arrangement not only limits possible bending damage to the rigid wire elements due to non-coaxial force that might be exerted on the lure by pulling, as might occur due to snagging or due to a large fish being played, but also, by keeping the rigid portions of the long axis of the lure short, the ability of a loosely hooked fish to use the lure as a lever to free itself is significantly reduced.

Finally, the proximal portion of this novel lure, consisting of the initial wire element carrying the attachment head and the rotating blade, can be used separately from the other features described in this invention, in that the proximal portion can be linked to, and set ahead of, many currently commercially available fishing lures, thereby given them the added attractiveness and fish-catching potential caused by the proximal portion's off-axis rotating blade.

There are therefore numerous advantages of the present invention, as listed below:

1. The invention's novel weight distribution, shifting the center of gravity towards the hook and away from the point of line attachment, ensures that lure-entangling and line-fowling during the casting process are minimized.

2. Further, the weight distribution of this lure increases the precision with which it can be cast to the suspected fish-holding location.

3. The invention's off axis rotation of the spinning blade adds a thumping pressure signal to the standard constant rotational signal of a spinner type lure, thereby increasing its attractiveness to fish.

4. Also owing to the described off-axis rotation pattern, the total resistance encountered during the retrieval of the lure is maximized, leading to an increase of the amplitude of all pressure signals emitted, thereby further increasing the lure's attractiveness to fish.

5. In the preferred embodiment, with more than one alternative line attachment aperture located at the rigid line attachment head mounted on the wire shaft, the angler can chose the angle at which the wire shaft moves in relation to the direction of travel of the lure, and thereby adjust the intensity of the pressure signals exactly to the fish's liking.

6. Owing to the fact that the hook is attached to a plurality of elements, rather than to a single, elongated and inflexible wire element as in traditional spinners, the lure cannot be misused by fish as a levering instrument to unhook themselves.

7. In the preferred embodiment, the rigid line attachment head mounted on the wire shaft offers space for decorative enhancements, an option not otherwise available for spinner type lures, such as decorative elements resembling eyes, known to attract fish to lures.

8. Given the non-coaxial relationship of the stiff wire shaft and the direction of pull, and given the surface area presented by the rigid wire attachment head, the rotational inertia of the lure is greatly increased, thereby preventing the rotational movements of the blade from rotating the wire shaft itself. This reduces line-twist, a vexing problem otherwise encountered with standard spinners, often forcing the angler to add a vane or weighted element to the lure assembly.

9. The front portion of this novel lure can be used separately, by linking it to lures already in the possession of the fisherman, thereby immediately increasing the fish catching potential of previously unsuccessful lures.

10. In summary, therefore, this novel lure is easier to cast precisely to its intended location, there will be reduced tangling and line-fowling, the lure looks better to fish, its thumping signals will prove virtually irresistible, and, once hooked, its flexible hook attachment will prevent fish from unhooking themselves.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1A is a perspective view of a traditional spinner;

FIG. 1B is a perspective view of a traditional spinner, whereby the rotational movement of the spinner blade is depicted, with the position of the blade shown at two points of its rotation, 180° apart;

FIG. 2A is a side view of a spinner bait;

FIG. 2B is a side view of a spinner bait, whereby the rotational movement of the spinner blades are depicted, with the position of the blades shown at two points of their rotation, 180° apart;

FIG. 3A is a perspective view of a traditional spinner with an elongated, triangular wire-shaft eye;

FIG. 3B is a perspective view of a traditional spinner with an elongated, triangular wire-shaft eye, caught on submerged roots, with attempts under way to free the lure from its entanglement;

FIG. 4 is a perspective view of a first embodiment of the current invention;

FIG. 5 is a perspective view of a second embodiment of the current invention;

FIG. 6 is a perspective view of a third embodiment of the current invention;

FIG. 7 is a perspective view of a fourth embodiment of the current invention;

FIGS. 8A-8D is an exploded perspective view of the parts needed to assemble the invention in its various preferred embodiments; and

FIG. 9-12 show side views of the preferred embodiment of the apparatus of the present invention illustrating fishing line attached to the lure at various attachment openings, further showing the effects of individual attachment positions on the rotational positions of the blade.

### DETAILED DESCRIPTION OF THE INVENTION

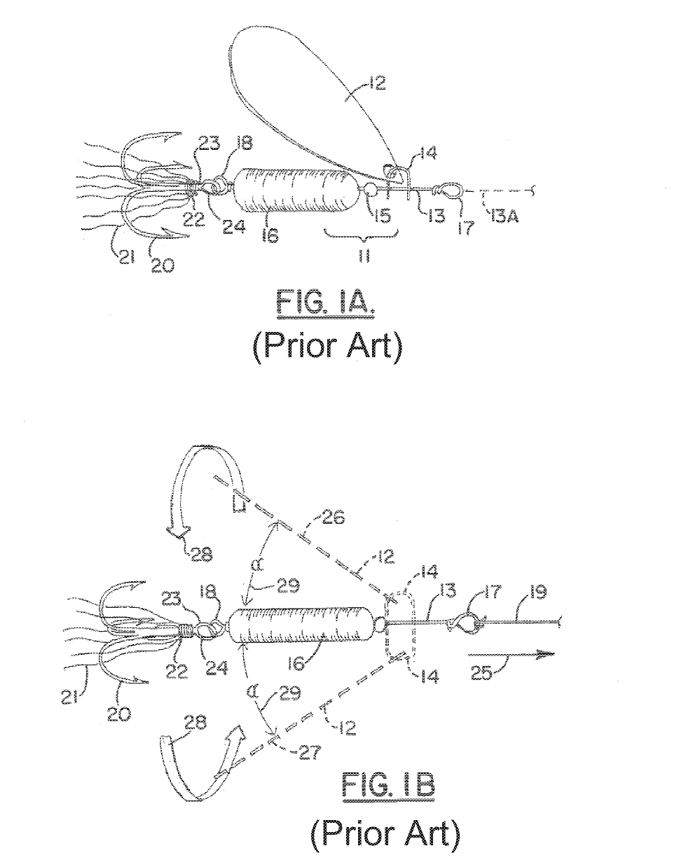

FIG. 1A shows a traditional spinner 11. A rotating blade 12 is mounted on a single wire shaft 13 by a clevis 14. Below clevis 14, a small metal or plastic bead 15, also mounted on wire axis 13, facilitates the rotational movements of clevis 14 and blade 12 around axis 13. Below bead 15, one or more lure body components 16 provide weight to allow for better casting of the lure. At the proximal and distal ends of single wire shaft 13, proximal wire shaft eye 17 and distal wire shaft eye 18 allow for the attachment of fishing line 19 (proximally) and of a treble hook 20 (distally). Most spinners also feature decorative dressing material 21 (often consisting of colored animal hair such as buck-tail material), attached with yarn 22 to hook shank 23 below hook eye 24.

FIG. 1B shows traditional spinner 11 in motion. Fishing line 19 is attached to proximal wire shaft eye 17, and spinner 11 is pulled through the water (not depicted) in a direction generally coaxial to fishing line 19 and axis 13, as indicated by arrow 25. The motion of spinner 11 against the resistance of the water leads to rotational movements of clevis 14 and blade 12 around wire 13. Ignoring the forces of gravity and water current, and assuming a constant velocity pull in a direction that is coaxial with wire 13, then blade 12 will rotate around wire 13 at an angle α that is dependent mainly upon the shape of blade 12 and, importantly, which is constant around the 360° of rotation. FIG. 1B demonstrates this by depicting blade 12, shown in broken lines, in an upper position 26 and in a lower position 27. Rotational movement direction of blade 12 is indicated by arrows 28, and blade/axle angle α, identical for upper 26 and lower 27 positions is indicated by arrows 29. Spinner type lures, exhibiting this constant angle rotation, emit a monotonous and ‘artificial’ pressure signal when retrieved.

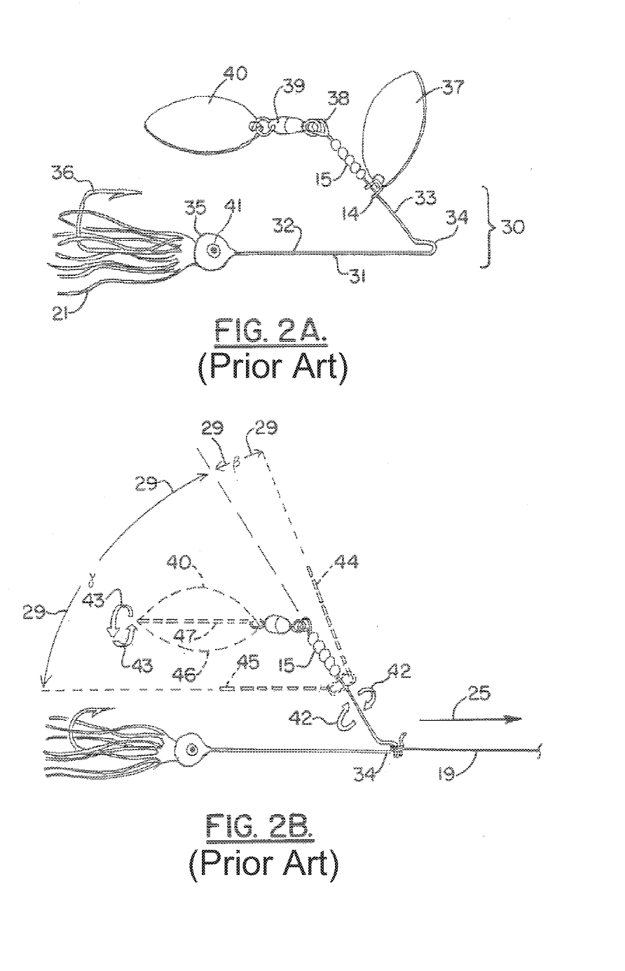

FIG. 2A depicts a typical spinner bait type lure 30. In its most common form, a V-shaped wire 31 has two arms, a straight arm 32 and an offset arm 33, joined by line attachment loop or bend 34. Straight arm 32, at its distal end, is joined to the proximal end of lure head-weight 35 which, in turn, is joined at its opposing end to single hook 36. Decorative dressing 21 is usually applied in a manner similar to traditional spinner 11. Offset arm 33 carries an upper blade 37, mounted rotatably to arm 33 by means of standard clevis 14. Distal to clevis 14, one or more beads 15 are mounted on arm 33, which then ends in distal offset arm eye 38. A standard swivel 39 is attached with one end to distal offset arm eye 38 and with its opposing end to lower blade 40. In its typical form, spinner bait 30 can feature a decorative eye painting 41 on both sides of lure head-weight 35.

FIG. 2B shows spinner bait 30 in motion. Fishing line 19 is attached to attachment loop 34, and spinner bait 30 is pulled through the water (not depicted) in a direction coaxial to fishing line 19 and relatively coaxial to straight arm 32, as indicated by arrow 25. The motion of spinner bait 30 against the resistance of the water leads to rotational movements of clevis 14 and upper blade 37 around offset arm 33, as well as to rotational movements of lower blade 40 and swivel 39 around their own long axes. Again ignoring the forces of gravity and water current, and assuming a constant velocity pull in a direction that is fairly coaxial with straight arm 32, but at an angle to offset arm 33, then upper blade 37 will rotate around offset arm 33 at a varying angle (indicated by arrows 29) that constantly shifts between narrow angle 13, located at the outside of spinner bait 30, and wide angle γ, located at the inside of spinner bait 30.

Direction of rotation of upper blade 37 is indicated by arrows 42, direction of rotation of lower blade 40 is indicated by arrows 43. In a manner similar to FIG. 1B, both moving blades are depicted as broken lines, whereby broken lines 44 show upper blade 37 in its uppermost position, forming narrow angle β with offset arm 33, and broken line 45 show upper blade 37 in its lowermost position, forming wide angle γ with offset arm 33. Lower blade 40 is shown in dotted or broken lines in two positions, in a plane parallel to the view at 47 and in a plane orthogonal to the view at 46. While rotating lower blade 40 offers virtually no resistance to the water and emits a minimal pressure signal, rotating upper blade 37 emits a strong rotational signal that constantly varies in intensity, leading to a ‘thumping’ pressure signal upon retrieval of the lure. As discussed above, however, this feature attracts the fish to the wrong wire arm: the arm without the hook.

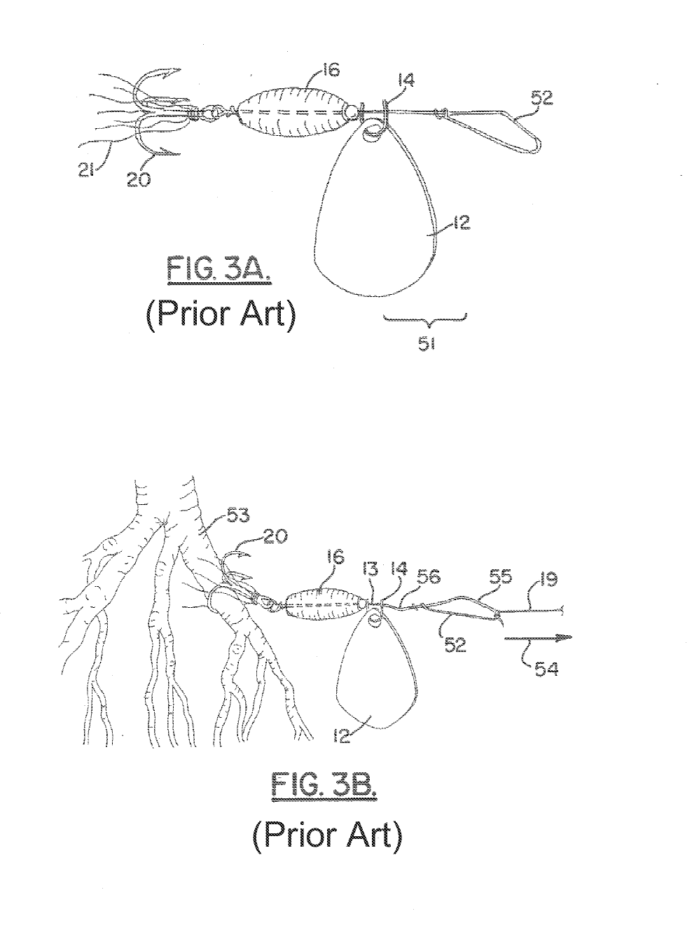

FIG. 3A shows a common modification 51 of the traditional spinner 11, featuring an elongated and triangular proximal wire shaft eye 52. Examples of such elongated and triangular proximal wire shaft eye are the above quoted fishing lure of Driesel (U.S. Pat. No. 4,998,371) or the currently commercially available Shyster® (Luhr-Jensen Co) spinner. Other elements of the lure, such as clevis 14, blade 12, lure body 16, treble hook 20 and dressing 21 are similar to the standard spinner model 11 featured in FIG. 1. While the purpose of this wire eye design appears to be to keep the lure body off center, thereby reducing line twist, that design, however, also imparts, nolens volens, a small degree of off-axis rotation to the movement of the blade. Regrettably, a larger degree of off-axis rotation that would lead to a significant degree of “thumping” in the lure's pressure signal could not be obtained if one were to exaggerate the size and angulation of the proximal wire shaft eye, owing to the inherent instability of the wire material, as further illustrated below.

FIG. 3B demonstrates the instability of the wire axis 13 and bent proximal wire shaft eye 52 of common spinner modification 51 when under pressure, a common scenario while fishing: Modified spinner 51 is caught, with treble hook 20, in the roots of submerged vegetation 53, and pull, indicated by arrow 54, is exerted to free the lure. Similar pressure will be exerted each time a larger fish is played. This pulling pressure damages and straightens triangular wire eye 52, reducing its angulation at point 55, while at the same time deforming single wire shaft axle 13 between bent wire eye 52 and clevis 14 at point 56, impeding the ability of clevis 14 to freely rotate. The problem is that, between the attachment points of fishing line 19 and treble hook 20, a single elongated rigid piece of wire (formed by wire axis 13 and bent wire shaft eye 52) cannot possibly withstand even those only modestly deformational forces routinely encountered while fishing.

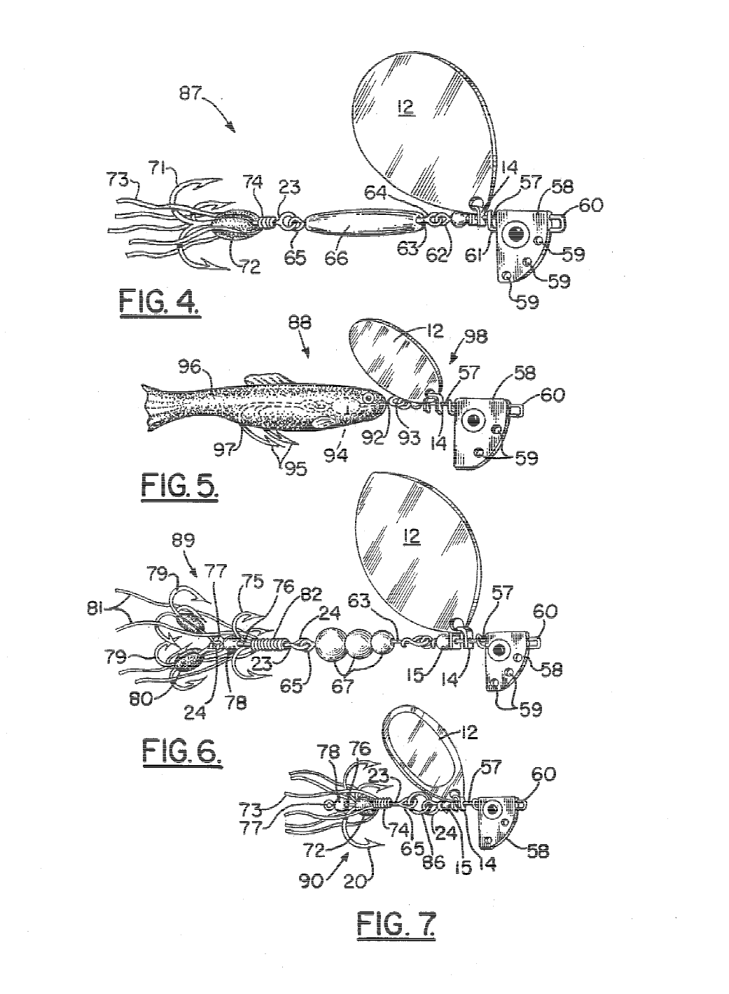

FIG. 4 illustrates a first embodiment of the apparatus of the present invention, designated generally by the numeral 87. A proximal wire part 57 (shown in more detail in a subsequent illustration) runs twice through rigid attachment head 58, forming upper loop 60 at the upper end or forward of attachment head 58, and lower loop 61 at the lower or rear end of attachment head 58, thereby securely attaching parts 57 and 58 to each other. Blade 12 attaches to wire 57 with clevis 14. Head 58 provides multiple openings 59, each opening providing an attachment position for a fishing line 19 and swivel 49. Loop 62 is provided at the distal end of proximal wire part 57. Distal loop 62 of proximal wire part 57 attaches to proximal loop 64 of distal wire part 63 which, in turn, by way of its distal loop 65 attaches to hook eye 24 of hook 71. Proximal wire part 57, below rigid attachment head 58, rotatably mounts clevis 14 attached to blade 12. Below clevis 14, a pearl or bead 15 is mounted on proximal wire part 57, ensuring clevis 14's free movement. Between its proximal loop 64 and its distal loop 65, distal wire part 63 carries lure body 66, made of light weight material (e.g., plastic). Treble hook 71 has a weight or lead element 72 mounted distally on its hook shaft 23. Mounted proximally on hook shaft 23 is attachment portion 74 of dressing 73.

FIG. 5 shows an alternative embodiment 88 of the present invention, showing its most versatile application. Similar to the first embodiment 87 are proximal wire part 57 and rigid attachment head 58 and their various features (e.g., blade 12, clevis 14). In FIG. 5, the ensemble of proximal wire part 57, attachment head 58, blade 12, clevis 14, and pearl 15 is referred to as upper lure assembly 98. This upper lure assembly 98 connects to a lower lure assembly 97, in FIG. 5 consisting of bait mounting wire 92 at bait mounting wire eye 93. Distally, bait mounting wire 92 carries internal weight 94, and, further distally yet, it connects to double hook 95. Mounted on this system consisting of elements 92,93,94,95 can be a soft plastic bait 96, as a typical example, in fish form. The unit of elements formed by parts 92-96 is given as an example of how lower lure assembly 97 can look. While lower lure assembly 97 is illustrated here as an internal mounting system carrying a soft plastic bait in fish form, any other standard soft plastic bait could be used or mounted on elements 92-95, or, alternatively, a natural dead bait could be mounted just as easily. Similarly, instead of elements 92-95, any standard and commercially available mounting system or rig for natural dead-baits or soft plastic baits could be used, in conjunction with a natural dead-bait or with a conventional soft plastic bait to form lower lure assembly 97. The versatility of this invention is due to the fact that upper lure assembly 98 can be used by itself as an independent fish-attracting element, to be combined with multiple currently commercially available products serving as lower lure assembly 97, including but not confined to standard dead-bait spinning rigs, standard soft plastic baits, crank-baits, or even standard spinners.

FIG. 6 illustrates another alternative embodiment 89 of the present invention. Similar to the first embodiment 87 are proximal wire part 57 and rigid attachment head 58 and their various features as seen in FIGS. 4-5 (e.g., blade 12, clevis 14). Proximal wire part 57 again connects to distal wire part 63 in a similar fashion, but distal wire part 63 carries a plurality of round body parts 67, again made of light weight material in the preferred embodiment.

Distal wire part 63, with its distal loop 65, connects to hook eye 24 of upper treble hook 75 which carries, parallel to hook shaft 23, wire brace 76 which, in turn, on its distal end carries weight element 78. In its distal-most portion, wire brace 76 forms loop 77 which, in turn, connects to hook eye(s) 24 of one or more lower treble hooks 79, each of which carry lead element or weight 80 around the distal aspects of their hook shafts 23. In this embodiment, long dressing 81 attaches with portion 82 to upper treble hook 75, covering upper hook 75 and lower hook(s) 79.

FIG. 7 shows a fourth embodiment 90 of the present invention. Rigid attachment head 58 and blade 12, as depicted in this example, are smaller, and the overall length of the lure is significantly shorter than in embodiments 87 and 89. Therefore, instead of distal wire part 63 or flexible wire material 68, proximal wire part 57 and hook eye 24 are joined by split ring 86; a single split ring 86 is used in the illustration, although a plurality of split rings can be used if needed. In this example, both lead element 72, mounted around hook shank 23, and weight element 78 attached with wire brace 76, provide a backward distribution of weight facilitating casting of embodiment 90, and preventing line entanglement. Distal loop 77 of wire brace 76 allows for the attachment of stinger hooks (not depicted) if desired.

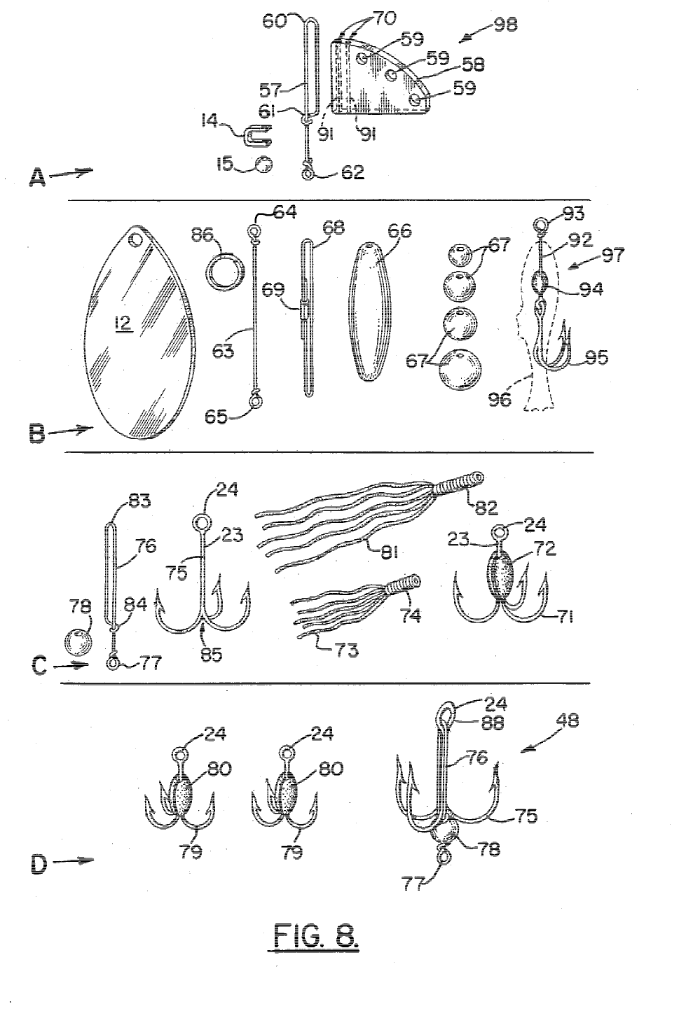

FIG. 8 illustrates the various component parts of the four suggested embodiments of FIGS. 4-7 in more detail. For ease of overview, the various parts are grouped in four different levels A, B, C, and D, in order of their location towards the proximal or distal end of the lure apparatus 87, 88, 89, 90.

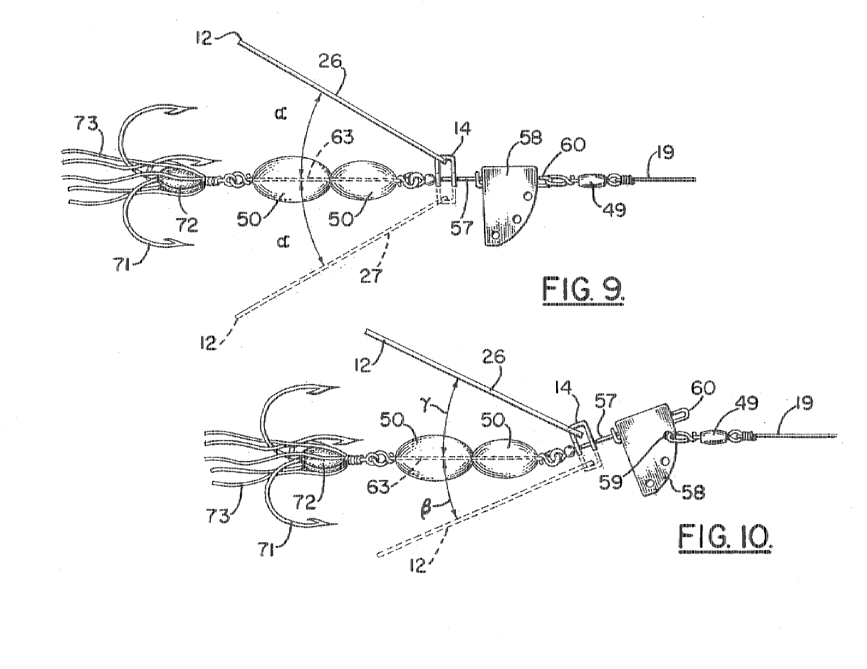

In FIG. 8, level A shows attachment head 58 with the two longitudinal openings 70, whose path through attachment head 58 is indicated by broken lines 91. The parallel wire portions of proximal wire part 57 fit in these longitudinal openings 70 and form upper loop 60 and lower loop 61, thereby securely connecting proximal wire part 57 to attachment head 58. Fishing line 19 can be attached upper loop 60, or directly to attachment head 58 at any one of attachment holes 59 (e.g., see FIGS. 9-12). Also shown at this level are clevis 14 and bead or pearl 15, which can be mounted on the lower portion of proximal wire part 57 in between lower loop 61 and distal loop 62. The ensemble of the parts depicted in level A, in conjunction with blade 12, form upper lure assembly 98. Upper lure assembly 98, in and by itself, without any of the other parts here depicted, can easily be combined with currently commercially available standard artificial lures or rigs, whereby upper lure assembly 98 would be attached proximally to fishing line, and distally, with loop 62, to whatever element is selected to serve as lower lure assembly 97, including but not confined to mounted natural baits, crank-baits, spinners, soft-plastic baits, or even spoons.

Level B shows distal wire part 63 with its proximal 64 and distal 65 attachment loops. As an alternative to distal wire part 63, flexible wire material 68 can be used, forming an elongated loop closed by way of a standard crimp sleeve 69. A plurality of loops formed of flexible wire material 68 could be used, for added safety. The advantage of using flexible wire material at this level is that it cannot be used by fish as leverage to unhook themselves. As another alternative, one or more split ring(s) 86 could be placed in between proximal wire part 57 and a hook eye 24. Further shown in FIG. 8, level B are oval single lure body part 66 or, as an alternative, rounded multiple lure body parts 67, made preferably of light weight material (e.g., plastic). No lure body parts are needed if wire part 57 and hook eye 24 are connected by one or more split ring(s) 86. Shown also is spinner blade 12 which can be chosen in a variety of shapes. Lastly, a standard system for the mounting of soft plastic baits or natural deadbaits is depicted, with bait mounting wire 92, proximal bait mounting wire eye 93, internal weight 94, twin hook 95, and, as a broken line silhouette, bait 96, shown in fish form, which could be a soft plastic artificial bait or a natural dead-bait.

In FIG. 8 at level C, most differences between the two embodiments 87 and 89, shown in FIGS. 4 and 6, respectively, are apparent. FIG. 4 embodiment 87 presented a single treble hook 71, carrying lead element 72 around its shank 23. Lead elements 72 can be oval shaped elongated lead pieces with a central longitudinal opening, slit open at the side, commercially available as ‘rubber core sinkers’, with the rubber core removed and the lead element firmly affixed to the distal portion of treble hook shank 23. In the single treble hook embodiment 87 of FIG. 4, short dressing 73 is fixed with its attachment portion 74 to the proximal portion of treble hook shank 23. To the left at level C are the elements pertaining to the embodiment 89 shown in FIG. 6. Wire brace 76 wraps around upper treble hook 75, whereby upper loop 83 of wire brace 76 fits through hook eye 24 of upper treble 75, and lower loop 84 of wire brace 76 cradles trifurcation 85 of upper treble 75. Weight element 78 is mounted on wire brace 76 between lower loop 84 and distal loop 77, thereby placing it directly below trifurcation 85.

In FIG. 8 at level D, one or more distal treble hook(s) 79 are shown which, in the assembled lure, are attached with their hook eye(s) 24 to distal loop 77 of wire brace 76. Also shown at level D, for added clarity, and given the numeral 48, is the hook 75, brace 76 and weight 78 assembly of those parts individually depicted at level C of FIG. 8.

FIGS. 9-12 show embodiments of the present invention in motion. In FIG. 9, fishing line 19 is attached to attachment head 58 by way of a snap swivel 49 (commercially available), and the effects of various attachment positions on the rotational angle of the blade are illustrated. In FIG. 9, swivel 49 attaches to upper loop 60 of proximal wire part 57, leading to a direction of travel of the lure essentially coaxial with fishing line 19 and proximal wire part 57. Similar to a traditional spinner 11 as depicted in FIG. 1, the motion of the lure against the resistance of the water leads to rotational movements of clevis 14 and blade 12 around proximal wire part 57. Blade 12 is shown in hard lines in an upper position 26 and in broken lines in a lower position 27. The blade/axle angle α (formed by blade 12 and underlying distal wire element 63) is identical for upper 26 and lower 27 positions. With this line attachment leading to constant angle rotation, the lure will emit a monotonous and ‘artificial’ pressure signal when retrieved, similar to a traditional spinner. Of note, two oval shaped lure body parts 50, hook 71, lead or weighted element 72 and dressing 73 are used in this illustration.

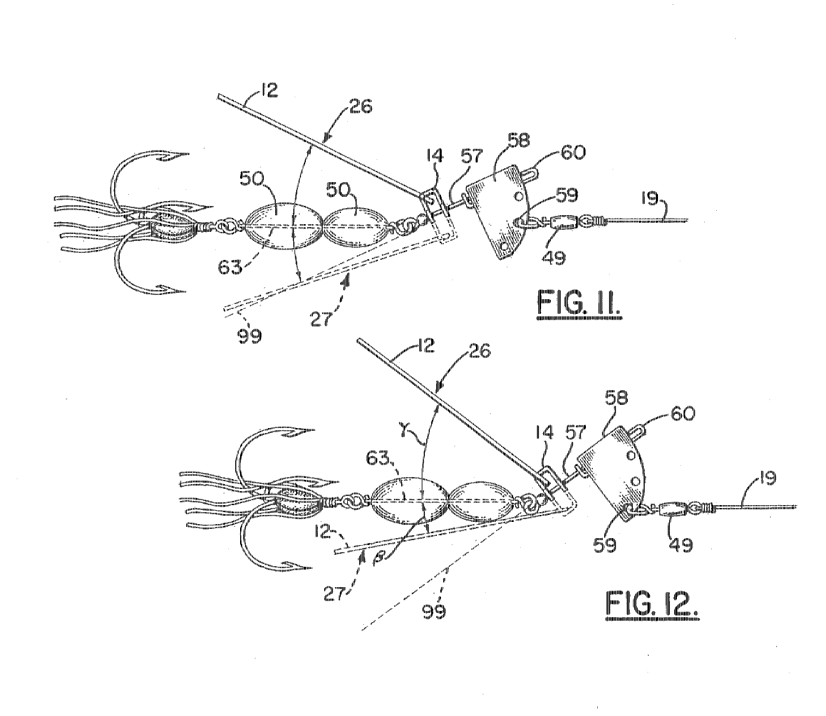

In FIG. 10, swivel 49 is attached to an attachment hole 59 in attachment head 58, thereby positioning proximal wire part 57 at a slight angle in relation to fishing line 19. This, in turn, results in blade 12 forming, in its upper position 26, a slightly larger blade/axle angle γ and, in its lower position 27, a slightly smaller blade/axle angle β. This asymmetry of rotation induces the ‘thumping’ signal referred to above.

In FIG. 11, an attachment hole 59 one position further away from upper loop 60 is chosen for line attachment, thereby further increasing the degree of asymmetry of blade 12 rotation. FIG. 12 shows the point of line attachment in the attachment hole 59 the furthest away from loop 60, thereby maximizing blade/axle angle γ and minimizing blade/axle angle β, and, consequently, maximizing the intensity of the ‘thumping’ signal emitted by the lure.

FIG. 11 further illustrates another important point, highlighting the significance of breaking up the lure's long axis into a plurality of segments for the functioning of this invention: if one were to attach head 58 to a single long wire axis as in traditional spinners, represented in FIGS. 11 and 12 as ‘hypothetical’ broken line 99, blade 12 in its lower position 27 would interfere with that axis and therefore be unable to rotate. Therefore, in order to allow blade 12 to rotate significantly off axis in relation to wire part 57, this part 57 has to be shortened, with the connection to treble hook 71 being formed by one or more parts 63 or 68 or 86 whose location puts them inside the rotational orbit of blade 12. It is therefore the combined effects of head 58's various attachment positions, and of the breaking down of the lure's long axis into a plurality of elements 57 and 63 (or 68 or 86) that enables blade 12 to engage in significant off axis rotation.

### PARTS LIST

Number Description
11 traditional in-line spinner
12 blade
13 single wire shaft axle
14 clevis
15 bead
16 lure body component
17 proximal wire shaft eye
18 distal wire shaft eye
19 fishing line
20 treble hook
21 dressing
22 yarn
23 hook shank
24 hook eye
25 arrow indicating direction of pull
26 upper blade position
27 lower blade position
28 arrows indicating rotational direction of blade
29 arrows indicating angle formed by rotating blade and wire shaft axle
30 spinner bait
31 V-shaped wire
32 straight arm
33 offset arm
34 attachment loop
35 head weight
36 single hook
37 upper blade
38 offset arm eye
39 standard swivel
40 lower blade
41 head weight decoration
42 rotational arrows for upper blade
43 rotational arrows for lower blade
44 upper blade in upper position
45 upper blade in lower position
46 lower blade in orthogonal position
47 lower blade in parallel position
48 hook, brace, and weight assembly
49 snap swivel
50 oval shaped multiple lure body parts
51 modified traditional inline spinner
52 bent proximal wire shaft eye
53 submerged vegetation
54 arrow indicating direction of pull
55 point indicating reduced angulation
56 point indicating wire shaft damage
57 proximal wire part
58 attachment head
59 attachment hole
60 upper loop
61 lower loop
62 distal loop of proximal wire part 57
63 distal wire part
64 proximal loop of distal wire part 63
65 distal loop of distal wire part 63
66 oval shaped single lure body
67 round shaped multiple lure body parts
68 flexible wire material
69 crimping sleeve
70 longitudinal openings of attachment head
71 treble hook
72 lead element of treble hook/weighted element
73 short dressing
74 attachment of short dressing
75 upper treble hook
76 wire brace
77 distal loop of wire brace 76
78 weight element of upper treble hook 75
79 lower treble hook
80 lead weight element of lower treble hook
81 long dressing
82 attachment of long dressing
83 upper loop of wire brace 76
84 lower loop of wire brace 76
85 trifurcation of upper treble 75
86 split ring
87 artificial spinner apparatus
88 artificial spinner apparatus
89 artificial spinner apparatus
90 artificial spinner apparatus
91 broken lines
92 bait mounting wire
93 proximal bait mounting wire eye
94 internal weight
95 double hook
96 bait
97 lower lure assembly
98 upper lure assembly
99 dotted line

The foregoing embodiments are presented by way of example only; the scope of the present invention is to be limited only by the following claims.

1. A spinner fishing lure apparatus, to be pulled through water, comprising:
a) a lure core portion having a proximal end and a distal end and a central axis;
b) said distal end having a connector that enables the attachment of one or more fishing hooks to the lure core portion;
c) at least one elongated axis element in between said proximal and said distal ends, said at least one elongated axis element allowing for the attachment of at least one rotationally mobile spinner blade, said at least one elongated axis element having a central, longitudinal axis;
d) a rigid head element attached to said at least one elongated axis element, said head element having one or more apertures, said one or more apertures allowing for the attachment of fishing line to said head element, at least one said aperture being laterally offset from said axis;
e) wherein the one or more planes of maximal area of said rigid head element that are orthogonal to the direction of pull of said lure are no more than ¼^{th} of the size of the one or more planes of maximal area of said rigid head element that are parallel to the direction of pull of said lure; and
f) whereby the pulling of said lure through water with said fishing line attached to said offset aperture of said rigid head element produces off axis rotation of said blade around said at least one elongated axis element.

2. A spinner fishing lure apparatus, to be pulled through water, comprising:
a) a lure core portion having a proximal end and a distal end;
b) said proximal end allowing for the attachment of fishing line, and said distal end allowing for the attachment of one or more fishing hooks;
c) the lure core portion including at least one elongated axis element in between said proximal and said distal ends, said at least one elongated axis element having a central, longitudinal axis and carrying at least one rotationally mobile blade that rotates about said axis;
d) a rigid element attached to said at least one elongated axis element, featuring a plurality of apertures offering alternative attachment options for fishing line at least two of said aperture being offset from said axis;
e) wherein there are one or more planes of maximal area of said rigid element that are orthogonal to the direction of pull of said lure and are no more than ¼^{th} of the size of the one or more planes of maximal area of said rigid element that are parallel to the direction of pull of said lure; and
f) wherein pulling of said lure through water with said fishing line attached to one of said offset ones of said plurality of apertures of said rigid element leads to off axis rotation of said blade around said at least one elongated axis element.

3. (canceled)

4. A spinner fishing lure apparatus comprising:
a) a core portion having a proximal end and a distal end;
b) said distal end allowing for the attachment of one or more fishing hooks;
c) a plurality of elongated elements in between said proximal and said distal ends;
d) at least one proximally located elongated element each having a central axis;
e) a rotationally mobile blade rotationally mounted on one said elongated element;
f) a rigid element attached to said at least one proximally located elongated element, said rigid element having one or more offset apertures allowing for the attachment of fishing line to the rigid element offset from said axis; and
g) wherein the pulling of said lure through water with said fishing line attached to one of said one or more apertures of said rigid element produces an off axis rotation of said blade around said at least one proximally located elongated element.

5-13. (canceled)

14. A fishing lure apparatus comprising:
a) a core portion having a proximal element and a distal element;
b) said proximal element having a proximal end and a distal end, said distal end allowing for the attachment of said proximal element to said distal element;
c) said proximal element consisting of an elongated element having a central axis;
d) a rotationally mobile blade mounted on said proximal element;
e) a rigid element attached to said elongated element proximally to said at least one rotationally mobile blade, said rigid element featuring one or more offset apertures allowing for the attachment of fishing line at selected positions that are laterally offset from said axis;
f) said distal element comprising a standard soft plastic bait containing at least one hook; and
g) whereby the pulling of said lure apparatus through water with said fishing line attached to one of said one or more offset apertures of said rigid element leads to off axis rotation of said blade around said elongated axis element of said proximal element.

15. A fishing lure apparatus comprising:
a) a core portion having a proximal element and a distal element;
b) said proximal element having a proximal end and a distal end, said distal end allowing for the attachment of said proximal element to said distal element;
c) said proximal element consisting of an elongated axis element allowing for the attachment of at least one rotationally mobile blade;
d) a rigid element attached to said elongated axis element proximally to said at least one rotationally mobile blade, said rigid element featuring one or more apertures allowing for the attachment of fishing line;
e) said distal element comprising a dead-bait spinning rig with at least one hook, allowing for the mounting of natural dead-baits; and
f) wherein the pulling of said lure through water with said fishing line attached to one of said one or more apertures of said rigid element leads to off axis rotation of said blade around said elongated axis element of said proximal element.

16. A fishing lure apparatus comprising:
a) a core portion having a proximal element and a distal element;
b) said proximal element having a proximal end and a distal end, said distal end pivotal enabling attachment of said proximal element to said distal element;
c) said proximal element consisting of an elongated element having a central axis and allowing for the attachment of at least one rotationally mobile blade;
d) a rigid element attached to said elongated axis element proximally to said at least one rotationally mobile blade, said rigid element having one or more offset apertures, each offset laterally from said axis and allowing for the attachment of a fishing line;
e) said distal element comprising a crank-bait containing at least one hook; and
f) wherein the pulling of said lure through water with said fishing line attached to one of said one or more apertures of said rigid element leads to off axis rotation of said blade around said elongated axis element of said proximal element.

17. A fishing lure apparatus comprising:
a) a core portion having an elongated element having a proximal end and a distal end, said distal end allowing for the attachment of said fishing lure apparatus to commercially available fishing lures, trailing behind said fishing lure apparatus;
b) said elongated element allowing for the attachment of at least one rotationally mobile blade;
c) a rigid element attached to said elongated element proximally to said at least one rotationally mobile blade, said rigid element featuring one or more apertures allowing for the alternative attachment of fishing line; and
d) whereby the pulling of said fishing lure apparatus through water with said fishing line attached to one of said one or more apertures of said rigid element leads to off axis rotation of said blade around said elongated axis element, thereby increasing the fish-catching potential of any commercially available fishing lure trailed behind said fishing lure apparatus.

18. A fishing lure apparatus comprising:
a) core portion having an elongated element having a proximal end and a distal end, said proximal end allowing for the attachment of fishing line, said distal end allowing for the attachment of said fishing lure apparatus to commercially available fishing lures, trailing behind said fishing lure apparatus;
b) said elongated element allowing for the attachment of at least one rotationally mobile blade;
c) a rigid element attached to said elongated element proximally to said at least one rotationally mobile blade, said rigid element featuring one or more apertures allowing for the alternative attachment of fishing line; and
d) whereby the pulling of said fishing lure apparatus through water with said fishing line attached to one of said one or more apertures of said rigid element leads to off axis rotation of said blade around said elongated axis element, thereby increasing the fish-catching potential of any commercially available fishing lure trailed behind said fishing lure apparatus.

19. A spinner fishing lure apparatus, comprising:
a) a lure core portion having a proximal end and a distal end;
b) said distal end having or forming a connector that enables the attachment of one or more fishing hooks;
c) at least one elongated element in between said proximal and said distal ends, said at least one elongated element allowing for the attachment of at least one rotationally mobile spinner blade;
d) a rigid head element attached to said at least one elongated axis element, said head element having one or more apertures, said one or more apertures allowing for the attachment of fishing line to the head element;
e) said head element being of lesser weight than the combined weight of all other parts of said spinner fishing lure apparatus;
f) whereby the pulling of said lure through water with said fishing line attached to one of said one or more apertures of said rigid element leads to a substantially non-coaxial position of said at least one elongated axis element in relationship to the direction of pull.

20. A spinner fishing lure apparatus, comprising:
a) a lure core portion having a proximal end and a distal end;
b) said distal end having or forming a connector that enables the attachment of one or more fishing hooks;
c) said proximal end having one or more apertures for the attachment of fishing line;
d) at least one elongated element in between said proximal and said distal ends, said at least one elongated element allowing for the attachment of at least one rotationally mobile spinner blade;
e) a rigid head element attached to said at least one elongated axis element;
f) said rigid head element being of lesser weight than the combined weight of all other parts of said spinner fishing lure apparatus; and
g) whereby said head element tilts said at least one elongated axis element into a substantially non-coaxial position in relationship to the direction of pull, when pulling said lure through water.

21. A spinner fishing lure apparatus to be pulled through water comprising:
a) a lure core portion having a proximal end and a distal end;
b) said distal end having or forming a connector that enables the attachment of one or more fishing hooks;
c) at least one elongated element in between said proximal and said distal ends, said at least one elongated element allowing for the attachment of at least one rotationally mobile spinner blade;
d) a rigid head element attached to said at least one elongated axis element, said head element having one or more apertures, said one or more apertures allowing for the attachment of fishing line to the head;
e) said rigid head element being of lesser weight than the combined weight of all other parts of said spinner fishing lure apparatus; and
f) whereby the pulling of said lure through water with said fishing line attached to one of said apertures of said rigid element leads to off axis rotation of said blade around said at least one elongated axis element.

22. A spinner fishing lure apparatus, comprising:
a) a lure core portion having a proximal end and a distal end;
b) said proximal end allowing for the attachment of fishing line, and said distal end allowing for the attachment of one or more fishing hooks;
c) at least one elongated axis element in between said proximal and said distal ends, said at least one elongated axis element allowing for the attachment of at least one rotationally mobile blade;
d) a rigid element attached to said at least one elongated axis element, featuring one or more apertures offering alternative attachment options for fishing line;
e) said rigid element being of lesser weight than the combined weight of all other parts of said spinner fishing lure apparatus; and
f) whereby the pulling of said lure through water with said fishing line attached to one of said one or more apertures of said rigid element leads to off axis rotation of said blade around said at least one elongated axis element.

23. A spinner lure fishing apparatus comprising;
a) a proximal end with a plurality of apertures for the attachment of fishing line;
b) a distal end allowing the attachment of one or more fishing hooks;
c) a middle portion with a rotatably movable blade mounted on it; and
d) whereby pulling the lure through water with said fishing line attached to one of said plurality of apertures leads to off axis rotation of said blade around at least one elongated axis element.

24. A spinner lure fishing apparatus component comprising;
a) a proximal end with a plurality of apertures for the attachment of fishing line;
b) a distal end allowing the attachment of one or more commercially available artificial fishing lures;
c) a middle portion with a rotatably movable blade mounted on it; and
d) whereby pulling the lure through water with said fishing line attached to one of said plurality of apertures leads to off axis rotation of said blade around at least one elongated axis element.

25. A spinner lure apparatus, to be pulled through water, comprising:
a) a lure core portion having a proximal end and a distal end;
b) said distal end having or forming a connector that enables the attachment of one or more fishing hooks;
c) at least one elongated element in between said proximal and said distal ends, allowing for the attachment of at least one rotationally mobile spinner blade, said elongated element having a central axis;
d) a rigid head element attached to said at least one elongated axis element, said head element having one or more offset apertures, each offset aperture being located spatially separated from said at least one elongated axis element, allowing for the attachment of fishing line to said head element at a position that is laterally offset from said axis;
e) whereby one or more planes of maximal area of said rigid head element that are orthogonal to the direction of pull of said lure are no more than ¼ of the size of the one or more planes of maximal area of said rigid head element that are parallel to the direction of pull of said lure; and
f) whereby the pulling of said lure through water with said fishing line attached to one of said offset apertures leads to off axis rotation of said blade around said at least one elongated axis element.

26. A spinner fishing lure apparatus, to be pulled through water, comprising:
a) a lure core portion having a proximal end and a distal end;
b) at least one elongated element in between said proximal and said distal ends, allowing the attachment of at least one rotationally mobile blade, said elongated element having a central axis;
c) a rigid head element attached to said at least one elongated element, said head element having more than one offset apertures located spatially separated from the central axis of said at least one elongated element;
d) wherein said offset apertures are located at varying distances from said central axis;
e) wherein pulling of said lure through water with said fishing line attached to one of said offset apertures leads to off axis rotation of said blade around said at least one elongated element; and
f) wherein the degree of said off axis rotation of said blade around said elongated element can be varied by changing the attachment of said fishing line from one of said more than one offset apertures to another one of said offset apertures.

27. A spinner fishing lure apparatus to be pulled through water, comprising:
a) a lure core portion having a proximal end and a distal end;
b) said distal end having or forming a connector that enables the attachment of one or more fishing hooks;
c) at least one elongated element in between said proximal and said distal ends, said at least one elongated element having a central axis;
d) a mobile spinner blade rotationally mounted upon said elongated element;
e) a rigid head element attached to said at least one elongated axis element, said head element having one or more offset apertures laterally separated from said central axis;
f) said rigid head element being of lesser weight than the combined weight of all other parts of said spinner fishing lure apparatus; and
g) wherein pulling of said lure through water with said fishing line attached to one of said offset apertures generates an off axis rotation of said blade around said at least one elongated axis element.

28. A spinner fishing lure apparatus, comprising:
a) a lure core portion having a proximal end and a distal end;
b) at least one elongated element in between said proximal and said distal ends, said at least one elongated element having a central axis;
c) a rotationally mounted mobile blade on said elongated element;
d) said head element having more than one offset apertures located laterally separated at varying distances from said offset axis, said more than one offset apertures allowing for the attachment of fishing line to a selected one of said offset apertures;
e) wherein pulling of said lure through water with said fishing line attached to one of said offset apertures produces an off axis rotation of said blade around said at least one elongated element; and
f) wherein the degree of said off axis rotation of said blade around said elongated element can be varied by changing the attachment of the fishing line from one of said offset apertures to another one of said offset apertures.

29. A spinner fishing lure apparatus comprising:
a) a core portion having a proximal end and a distal end;
b) said distal end allowing for the attachment of one or more fishing hooks;
c) a plurality of elongated elements in between said proximal and said distal ends, with at least one proximally located elongated axis element having a central axis;
d) a rotationally mobile blade mounted on the proximally located elongated axis element;
e) a rigid head element attached to said at least one elongated axis element having a central axis, said head element having one or more offset apertures that located spatially separated from said axis;
f) said offset apertures located laterally separated from said axis; and
g) wherein the pulling of said lure through water with said fishing line attached to one of said offset apertures generates an off axis rotation of said blade around said at least one proximally located elongated element.
